(19) United States
(12) Patent Application Publication
(10) Pub. No.: US 2018/0376293 A1
(43) Pub. Date: Dec. 27, 2018

(54) INDOOR POSITIONING SYSTEM AND RELATED METHOD

(71) Applicant: ROBOTELF TECHNOLOGY CO., LTD., Taipei City (TW)

(72) Inventor: Ling-Feng Chen, Taipei City (TW)

(21) Appl. No.: 15/633,765

(22) Filed: Jun. 27, 2017

(51) Int. Cl. H04W 4/04; G01S 15/06; G01S 15/89; G05B 19/042; H04W 4/02

(52) U.S. Cl. CPC H04W 4/04; G01S 15/06; H04W 4/025; G05B 19/042; G01S 15/89

(57) ABSTRACT

The indoor positioning system includes a mobile device, a remote controller, and three RF positioning devices. The RF positioning devices are located at different locations within an indoor space. The mobile device receives and detects strengths of RF signals from the RF positioning devices, and constructs a grid of relative areas within the indoor space accordingly. The mobile device is controlled by the remote controller to move for a number of distances and directions within the inner space so as to integrate the distances and directions with the gird of relative areas into a coordinate system. The mobile device therefore is able to move precisely within the indoor space, either by the remote controller or autonomously.

### BACKGROUND OF THE INVENTION

### (a) Technical Field of the Invention

The present invention generally relates to positioning and, more particularly, to an indoor positioning system and method for domestic intelligent robot.

### (b) Description of the Prior Art

To make home life more convenient and safe, the development of domestic intelligent robot is gaining attention. A domestic intelligent robot may be used for the surveillance of intruders, environmental monitoring, house cleaning, etc. It can also be used for home management such as reminding important matters, weather forecasting, providing care and company, emergency notification, etc.

The key for a domestic intelligent robot to move freely within the household is a precise indoor positioning system. However, to customize such a system to fit a specific household, a professional is usually required, resulting in tedious process and costly expense.

Therefore, a major object of the present invention is to provide a convenient indoor positioning system for non-professionals

### SUMMARY OF THE INVENTION

A novel indoor positioning system is disclosed herein, which includes a mobile device, a remote controller, and three RF positioning devices. The RF positioning devices are located at different locations within an indoor space. The mobile device receives and detects strengths of RF signals from the RF positioning devices, and constructs a grid of relative areas within the indoor space accordingly. The mobile device is controlled by the remote controller to move for a number of distances and directions within the inner space so as to integrate the distances and directions with the gird of relative areas into a coordinate system. The mobile device therefore is able to move precisely within the indoor space, either by the remote controller or autonomously.

An indoor positioning method is also disclosed, which includes the following steps. Firstly, the RF positioning devices are disposed at different locations within the indoor space and, by the strengths of the RF signals received by the mobile device, the mobile device constructs a grid of relative areas within the indoor space. Secondly, through the remote controller, the mobile device is manually controlled to move from the first RF positioning device to the second RF positioning device and then is instructed to return autonomously from the second RF positioning device to the first RF positioning device. In the process physical distances to and the strengths of the RF signals from the RF positioning devices are recorded and associated with the areas traversed. Thirdly, through the remote controller, the mobile device is manually controlled to move from the first RF positioning device to the third RF positioning device and then is instructed to return autonomously from the third RF positioning device to the first RF positioning device. In the process physical distances to and the strengths of the RF signals from the RF positioning devices are recorded and associated with the areas traversed. Finally, an indoor coordinate system is constructed by the mobile device integrating the information collected from the previous steps so that the mobile device may move precisely within the indoor space, either by the remote controller or autonomously.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing an indoor positioning system according to an embodiment of the present invention.

FIG. 2 is a flow diagram showing the steps of an indoor positioning method according to an embodiment of the present invention.

FIG. 3 is a schematic diagram showing a grid of relative areas determined by an indoor positioning system according to the present invention.

FIG. 4 is a schematic diagram showing the trajectory of a mobile device moving within the grid of relative areas of FIG. 3 without obstacles according to the present invention.

FIG. 5 is a schematic diagram showing the trajectory of a mobile device moving within the grid of relative areas of FIG. 3 with obstacles according to the present invention.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

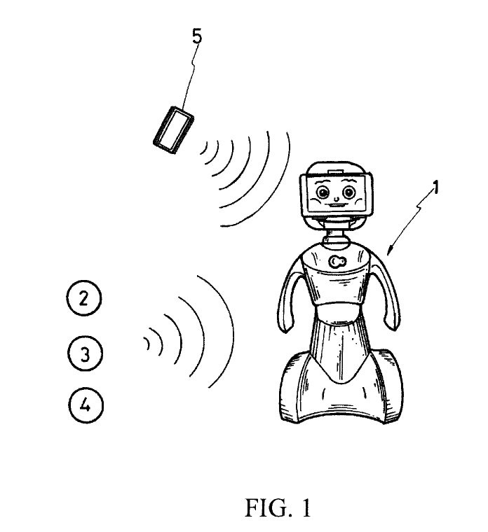

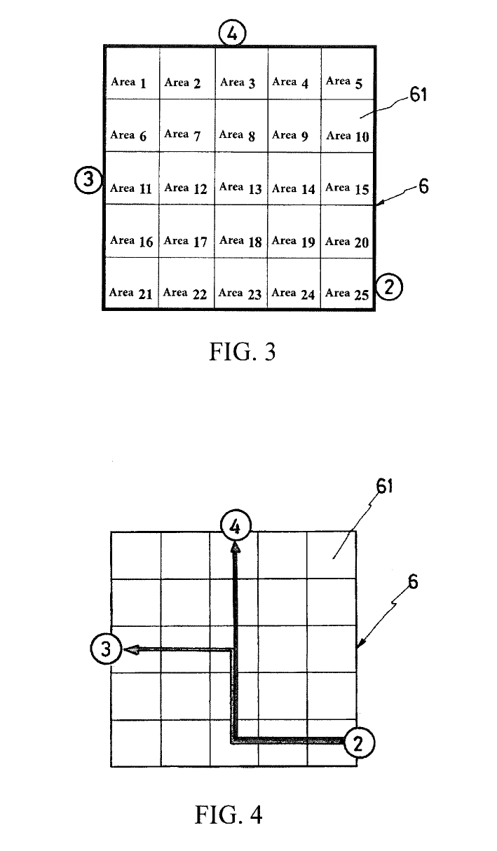

As shown in FIGS. 1 and 3, an indoor positioning system according to an embodiment of the present invention includes a remotely controllable mobile device 1, a first radio-frequency (RF) positioning device 2, a second RF positioning device 3, a third RF positioning device 4, and a remote controller 5.

The mobile device 1 detects the strength/weakness of RF signals respectively emitted from the RF positioning devices 2, 3, 4 within an indoor space 6. The mobile device 1 further receives a remote control signal from the remote controller 5. The mobile device 1 has an autonomous or manually controlled moving and direction-changing capability, and a capability of detecting and avoiding obstacle. The mobile device 1 may be a manually controlled or autonomous robotic device. The mobile device 1 includes a control module 11, a motor-driven wheel set 12, and a signal processing module 13, all electrically connected together. The control module 11 is a control circuit with a RF reception unit, a wireless network transmission unit, a direction detection unit, and an obstacle detection unit. The RF reception module receives at least one of the RF signals, and the wireless network transmission unit receives at least a wireless network signal. The direction detection unit detects a direction of the mobile device 1, and may be an electronic compass or a gyroscope. The obstacle detection unit detects the presence of obstacle around the mobile device 1 by means such as supersonic wave. The wheel set 12 may make a specific number of turns along a specific direction as instructed. The signal processing module 13 is a processor handling signals from the control module 11 such as RF signals, wireless network signals, direction detection signals, obstacle detection signals, etc., and instructing the wheel set 12 to turn a specific number of turns along a specific direction. The signal processing module 13 includes a touch-sensitive display.

The first RF positioning device 2 is positioned at a first location within an indoor space 6. The RF signal transmitted from the first RF positioning device 2 would be detected and picked up by the RF reception module and processed by the signal processing module 13 of the mobile device 1.

The second RF positioning device 3 is positioned at a second location within the indoor space 6. The RF signal transmitted from the second RF positioning device 3 would be detected and picked up by the RF reception module and processed by the signal processing module 13 of the mobile device 1.

The third RF positioning device 4 is positioned at a third location within the indoor space 6. The RF signal transmitted from the third RF positioning device 4 would be detected and picked up by the RF reception module and processed by the signal processing module 13 of the mobile device 1.

The remote controller 5 may transmit a wireless control signal to the mobile device 1 to instruct the mobile device 1 to move for a specific distance along a specific direction. The wireless control signal may be detected and picked by the wireless network signal transmission unit and processed by the signal processing module 13 of the mobile device 1, which in turn instructs the wheel set 12 to make a specific number of turns along the specified direction.

In one embodiment, the RF positioning devices 2, 3, 4 are positioned at different locations within the indoor space 6. By the strengths of the RF signals received, the mobile device 1 is able to construct a grid of relative areas 61 within the indoor space 6, as shown in FIG. 3. The location of each area 61 is determined by the RF signals of different strengths. Then by instructing the mobile device 1 to move a specific distance in a specific direction through the remote controller 5, the physical distance and direction are associated with the grid of relative areas 61 so that a precise indoor coordinate system is constructed. Therefore, the mobile device 1 is able to accurately move from one location to another within the indoor space. A user is able to achieve the indoor positioning of the mobile device 1 conveniently.

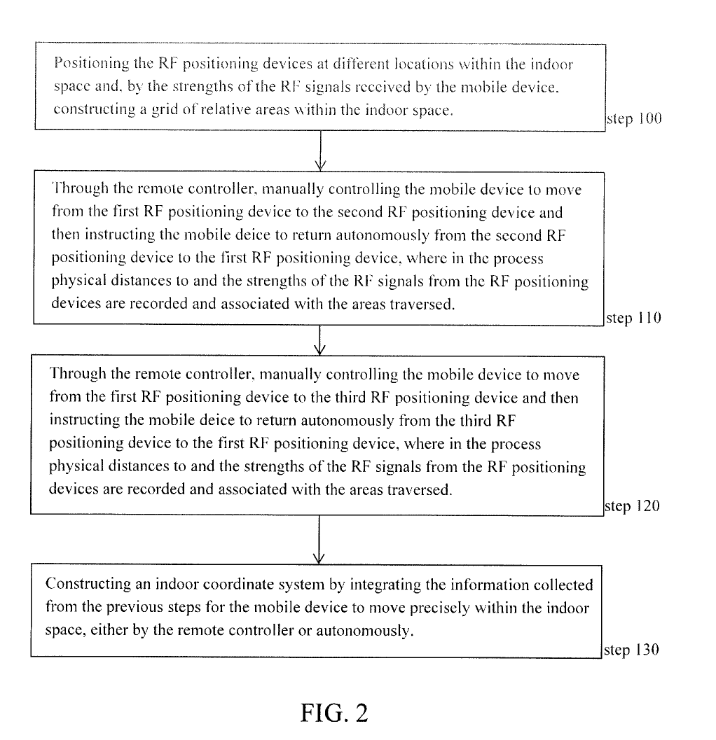

As shown in FIGS. 2, 4, and 5, a positioning method according to an embodiment of the present invention includes the following steps.

In step 100, the RF positioning devices 2, 3, 4 are positioned at different locations within the indoor space 6 and, by the strengths of the RF signals received by the mobile device 1, a grid of relative areas 61 within the indoor space 6 is constructed.

In step 110, the remote controller 5 is applied to control the mobile device 1 to move from the first RF positioning device 2 to the second RF positioning device 3 in a stepwise manner (e.g., advancing 0.5 meter for each step). After the mobile device 1 reaches the second RF positioning device 3, the mobile device 1 is instructed to move autonomously in a reversed order of the previous steps so that the mobile device 1 returns to the first RF positioning device 2 from the second RF positioning device 3. In the process, the mobile device 1 is able to record its physical distances to and the strengths of the RF signals from the RF positioning devices 2, 3, 4 and associates these information with the traversed areas 61.

In step 120, the remote controller 5 is applied to control the mobile device 1 to move from the first RF positioning device 2 to the third RF positioning device 4 in a stepwise manner (e.g., advancing 0.5 meter for each step). After the mobile device 1 reaches the third RF positioning device 4, the mobile device 1 is instructed to move autonomously in a reversed order of the previous steps so that the mobile device 1 returns to the first RF positioning device 2 from the third RF positioning device 4. In the process, the mobile device 1 is able to record its physical distances to and the strengths of the RF signals from the RF positioning devices 2, 3, 4 and associates these signal strength information with the traversed areas 61.

In step 130, an indoor coordinate system is constructed by integrating the information collected from the steps 110 and 120. As such, the mobile device 1 may move precisely within the indoor space 6, either by the remote controller 5 or autonomously.

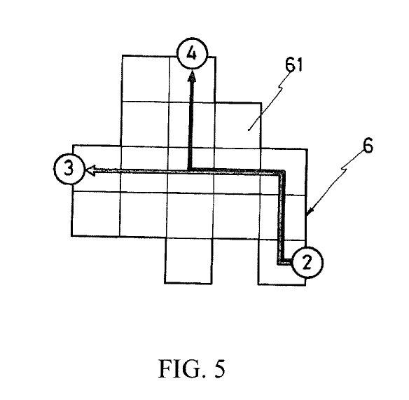

In steps 110 and 120, if there are obstacles within the indoor space 6, the obstacle detection unit may detect these obstacles and automatically avoid them, as shown in FIG. 5.

Please note that it is possible that there are areas 61 where the RF signals are close or identical so that the mobile device 1 may not be able to differentiate then. In this case, the mobile device 1 may move along an arbitrary direction into an area 61 having differentiable RF signal strength and as such may be able to determine its coordinates. And the mobile device 1 may continue its travel towards the destination.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An indoor positioning system for an indoor space, comprising:
a mobile device capable of moving and direction changing autonomously or under remote control;
a first radio-frequency (RF) positioning device positioned at a first location within the indoor space emitting a first RF signal;
a second RF positioning device positioned at a second location within the indoor space emitting a second RF signal;
a third RF positioning device positioned at a third location within the indoor space emitting a third RF signal; and
a remote controller for issuing a wireless control signal to the mobile device so as to remotely control the mobile device;
wherein the mobile device receives and detects strengths of the first, second, and third RF signals, and constructs a grid of relative areas within the indoor space accordingly; and the mobile device is controlled by the remote controller to move for a plurality of distances and directions within the inner space so as to integrate the distances and directions with the gird of relative areas into a coordinate system.

2. The indoor positioning system according to claim 1, wherein the mobile device comprises a control module, a motor-driven wheel set, and a signal processing module, all electrically connected together; the control module comprises a RF reception unit, a wireless network transmission unit, a direction detection unit, and an obstacle detection unit; the RF reception module receives at least one of the RF signals, and the wireless network transmission unit receives at least a wireless network signal; the direction detection unit detects a direction of the mobile device; the obstacle detection unit detects the presence of obstacle around the mobile device; the wheel set make a specific number of turns along a specific direction as instructed; the signal processing module handles signals from the control module and instructs the wheel set to turn a specific number of turns along a specific direction.

3. The indoor positioning system according to claim 1, wherein the control module is a circuit board; the direction detection unit is an electronic compass or a gyroscope; the direction detection unit is an electronic compass or a gyroscope; the signal processing module is a processor; and the signal processing module has a touch-sensitive display.

4. An indoor positioning system method applied to the indoor positioning system of claim 1, comprising the steps of:
positioning the RF positioning devices at different locations within the indoor space and, by the strengths of the RF signals received by the mobile device, constructing a grid of relative areas within the indoor space;
through the remote controller, manually controlling the mobile device to move from the first RF positioning device to the second RF positioning device and then instructing the mobile deice to return autonomously from the second RF positioning device to the first RF positioning device, where in the process physical distances to and the strengths of the RF signals from the RF positioning devices are recorded and associated with the areas traversed;
through the remote controller, manually controlling the mobile device to move from the first RF positioning device to the third RF positioning device and then instructing the mobile deice to return autonomously from the third RF positioning device to the first RF positioning device, where in the process physical distances to and the strengths of the RF signals from the RF positioning devices are recorded and associated with the areas traversed; and
constructing an indoor coordinate system by integrating the information collected from the previous steps for the mobile device to move precisely within the indoor space, either by the remote controller or autonomously.
